(19) United States
(12) Patent Application Publication
(10) Pub. No.: US 2016/0111772 A1
(43) Pub. Date: Apr. 21, 2016

(54) LOOP ANTENNA WITH A PARASITIC ELEMENT INSIDE

(71) Applicant: Microsoft Corporation, Redmond, WA (US)

(72) Inventor: Juha Lilja, Tampere (FI)

(21) Appl. No.: 14/516,356

(22) Filed: Oct. 16, 2014

(51) Int. Cl. H01Q 1/24; H01Q 7/00

(52) U.S. Cl. CPC H01Q 1/243; H01Q 7/00

(57) ABSTRACT

A loop antenna with a parasitic element inside is described. In an embodiment, the loop antenna comprises a loop element that has a feed contact and a ground contact. The loop antenna further comprises a first parasitic element that is arranged inside the loop element and that acts as a first slot radiator. A first end of the first parasitic element is physically connected to the loop element thereby forming a closed end of the first slot radiator. The first slot radiator further has an open end that is closer to the feed contact and the ground contact than its closed end.

### BACKGROUND

Loop antennas, for example single folded loop antennas, are often used in mobile apparatuses, for example in mobile handsets. Typically, such a loop antenna may comprise one resonance to cover GSM 850/900 band as well as WCDMA V and VIII bands. Alternatively, two separate resonances may be used for the higher frequencies (GSM 1800/1900, WCDMA I and II) such that the lower resonance of these high band resonances has a balanced current distribution, and the higher resonance has a common mode current distribution.

### SUMMARY

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

A loop antenna comprises a loop element that has a feed contact and a ground contact. The loop antenna further comprises a first parasitic element that is arranged inside the loop element and that acts as a first slot radiator. A first end of the first parasitic element is physically connected to the loop element thereby forming a closed end of the first slot radiator. The first slot radiator further has an open end that is closer to the feed contact and the ground contact than its closed end.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIGS. 1a-1e are diagrams of various embodiments of a loop antenna;

FIGS. 2a-2c are 3D views of various embodiments of a loop antenna;

FIG. 3 is a block diagram of a mobile apparatus;

FIGS. 4a-4b illustrate currents and electric fields associated with a loop antenna, respectively; and

FIG. 5 illustrates resonances created with a loop antenna.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples may be described and illustrated herein as being implemented in a smartphone or a mobile phone, these are only examples of a mobile apparatus and not a limitation. As those skilled in the art will appreciate, the present examples are suitable for application in a variety of different types of mobile apparatuses, for example, in tablets etc.

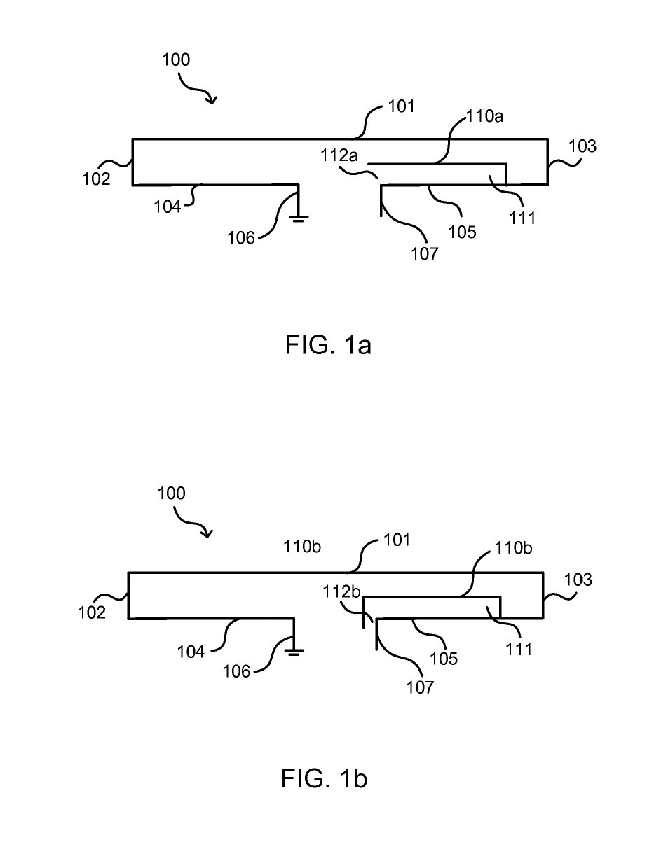

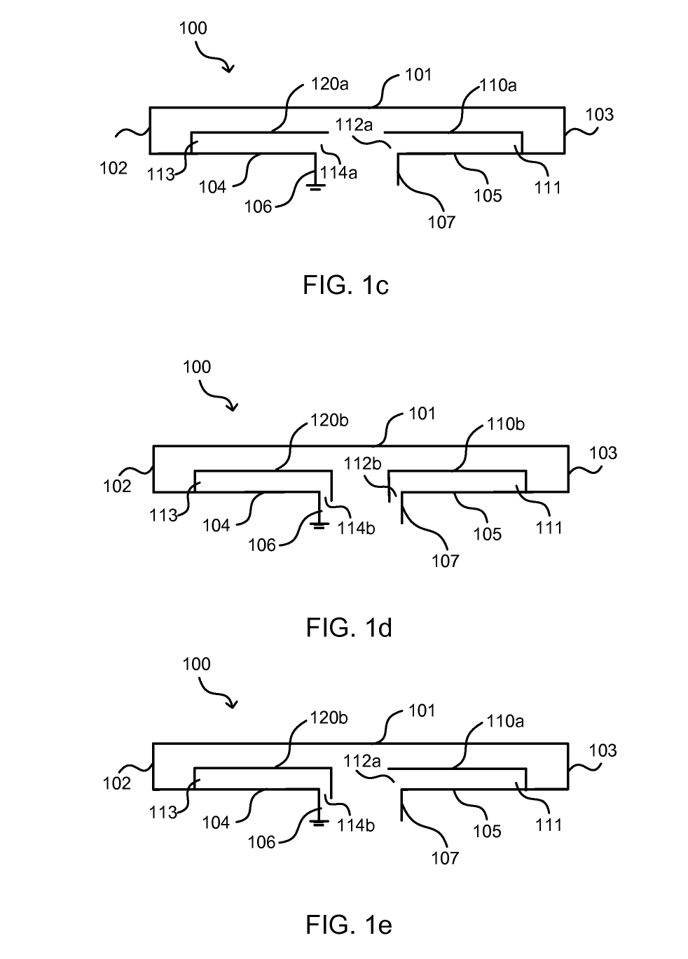

FIGS. 1a-1e show embodiments of a loop antenna 100. The loop antenna 100 comprises a loop element that has a feed contact 107 and a ground contact 106. The loop element comprises a first lower portion 104 and a second lower portion 105, an upper portion 101, a first side portion 102 that connects the first lower portion 104 and the upper portion 101, and a second side portion 103 that connects the second lower portion 105 and the upper portion 101. The first lower portion 104 is connected to the ground contact 106, and the second lower portion 105 is connected to the feed contact 107. In the shown embodiments, the loop element 101-107 comprises a folded loop element. However, the invention is not limited to a folded loop element.

In the embodiment of FIG. 1a, the loop antenna 100 further comprises a first parasitic element 110a that is arranged inside the loop element 101-107. The first parasitic element 110a acts as a first slot radiator. A first end of the first parasitic element 110a is physically connected to the loop element 101-107 thereby forming a closed end 111 of the first slot radiator. More particularly, the first parasitic element 110a may be physically connected to the second lower portion 105 of the loop element, as shown in FIG. 1a. The first slot radiator further has an open end 112a that is closer to the feed contact 107 and the ground contact 106 than its closed end 111. In the embodiment of FIG. 1a, the first parasitic element 110a extends substantially linearly from the closed end 111 of the first slot radiator towards the open end 112a of the first slot radiator.

In the embodiment of FIG. 1b, the loop antenna 100 further comprises a first parasitic element 110b that is arranged inside the loop element 101-107. The first parasitic element 110b acts as a first slot radiator. A first end of the first parasitic element 110b is physically connected to the loop element 101-107 thereby forming a closed end 111 of the first slot radiator. More particularly, the first parasitic element 110b may be physically connected to the second lower portion 105 of the loop element, as shown in FIG. 1b. The first slot radiator further has an open end 112b that is closer to the feed contact 107 and the ground contact 106 than its closed end 111. In the embodiment of FIG. 1b, the first parasitic element 110b first extends substantially linearly from the closed end 111 of the first slot radiator towards the open end 112b of the first slot radiator and then bends along one of the feed contact 107 and the ground contact 106 at the open end 112b of the first slot radiator.

In the embodiment of FIG. 1c, the loop antenna 100 comprises two parasitic elements. The loop antenna 100 comprises a first parasitic element 110a that is arranged inside the loop element 101-107. The first parasitic element 110a acts as a first slot radiator. A first end of the first parasitic element 110a is physically connected to the loop element 101-107 thereby forming a closed end 111 of the first slot radiator. More particularly, the first parasitic element 110a may be physically connected to the second lower portion 105 of the loop element, as shown in FIG. 1c. The first slot radiator further has an open end 112a that is closer to the feed contact 107 and the ground contact 106 than its closed end 111. In the embodiment of FIG. 1c, the first parasitic element 110a extends substantially linearly from the closed end 111 of the first slot radiator towards the open end 112a of the first slot radiator.

In the embodiment of FIG. 1c, the loop antenna 100 further comprises a second parasitic element 120a that is arranged inside the loop element 101-107. The second parasitic element 120a acts as a second slot radiator. A first end of the second parasitic element 120a is physically connected to the loop element 101-107 thereby forming a closed end 113 of the second slot radiator. More particularly, the second parasitic element 120a may be physically connected to the first lower portion 104 of the loop element, as shown in FIG. 1c. The second slot radiator further has an open end 114a that is closer to the feed contact 107 and the ground contact 106 than its closed end 113. In the embodiment of FIG. 1c, the second parasitic element 120a extends substantially linearly from the closed end 113 of the second slot radiator towards the open end 114a of the second slot radiator.

In the embodiment of FIG. 1d, the loop antenna 100 comprises two parasitic elements. The loop antenna 100 comprises a first parasitic element 110b that is arranged inside the loop element 101-107. The first parasitic element 110b acts as a first slot radiator. A first end of the first parasitic element 110b is physically connected to the loop element 101-107 thereby forming a closed end 111 of the first slot radiator. More particularly, the first parasitic element 110b may be physically connected to the second lower portion 105 of the loop element, as shown in FIG. 1d. The first slot radiator further has an open end 112b that is closer to the feed contact 107 and the ground contact 106 than its closed end 111. In the embodiment of FIG. 1d, the first parasitic element 110b first extends substantially linearly from the closed end 111 of the first slot radiator towards the open end 112b of the first slot radiator and then bends along one of the feed contact 107 and the ground contact 106 at the open end 112b of the first slot radiator.

In the embodiment of FIG. 1d, the loop antenna 100 further comprises a second parasitic element 120b that is arranged inside the loop element 101-107. The second parasitic element 120b acts as a second slot radiator. A first end of the second parasitic element 120b is physically connected to the loop element 101-107 thereby forming a closed end 113 of the second slot radiator. More particularly, the second parasitic element 120b may be physically connected to the first lower portion 104 of the loop element, as shown in FIG. 1d. The second slot radiator further has an open end 114b that is closer to the feed contact 107 and the ground contact 106 than its closed end 113. In the embodiment of FIG. 1d, the second parasitic element 120b first extends substantially linearly from the closed end 111 of the first slot radiator towards the open end 112b of the first slot radiator and then bends along one of the feed contact 107 and the ground contact 106 at the open end 112b of the first slot radiator.

In the embodiment of FIG. 1e, the loop antenna 100 comprises two parasitic elements. The loop antenna 100 comprises a first parasitic element 110a that is arranged inside the loop element 101-107. The first parasitic element 110a acts as a first slot radiator. A first end of the first parasitic element 110a is physically connected to the loop element 101-107 thereby forming a closed end 111 of the first slot radiator. More particularly, the first parasitic element 110a may be physically connected to the second lower portion 105 of the loop element, as shown in FIG. 1e. The first slot radiator further has an open end 112a that is closer to the feed contact 107 and the ground contact 106 than its closed end 111. In the embodiment of FIG. 1e, the first parasitic element 110a extends substantially linearly from the closed end 111 of the first slot radiator towards the open end 112a of the first slot radiator.

In the embodiment of FIG. 1e, the loop antenna 100 further comprises a second parasitic element 120b that is arranged inside the loop element 101-107. The second parasitic element 120b acts as a second slot radiator. A first end of the second parasitic element 120b is physically connected to the loop element 101-107 thereby forming a closed end 113 of the second slot radiator. More particularly, the second parasitic element 120b may be physically connected to the first lower portion 104 of the loop element, as shown in FIG. 1e. The second slot radiator further has an open end 114b that is closer to the feed contact 107 and the ground contact 106 than its closed end 113. In the embodiment of FIG. 1e, the second parasitic element 120b first extends substantially linearly from the closed end 111 of the first slot radiator towards the open end 112b of the first slot radiator and then bends along one of the feed contact 107 and the ground contact 106 at the open end 112b of the first slot radiator.

In other words, the first parasitic element 110a, 110b and the second lower portion 105 of the loop element may form a slot between them that acts as a radiator. Similarly, the second parasitic element 120a, 120b and the first lower portion 104 of the loop element may form a slot between them that acts as a radiator.

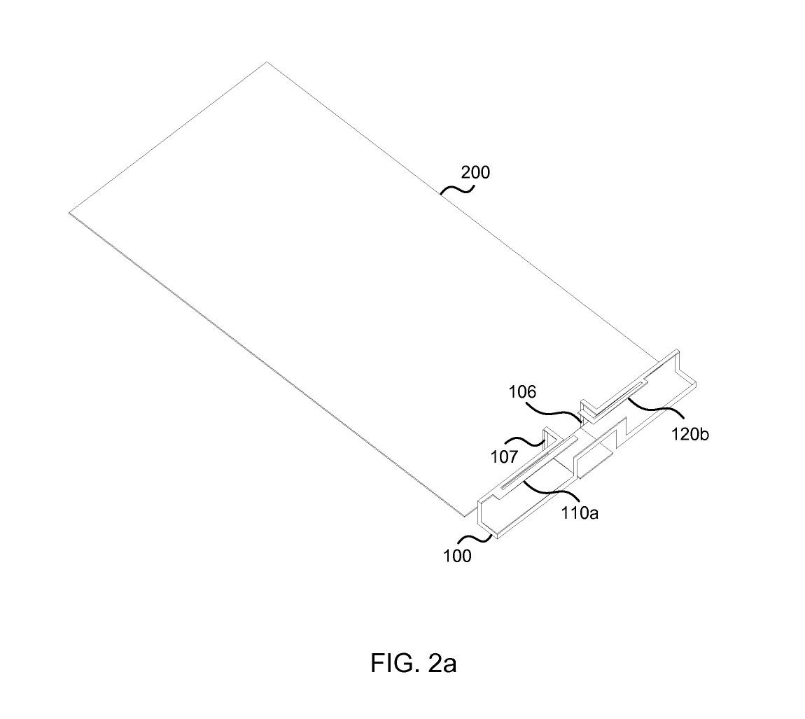

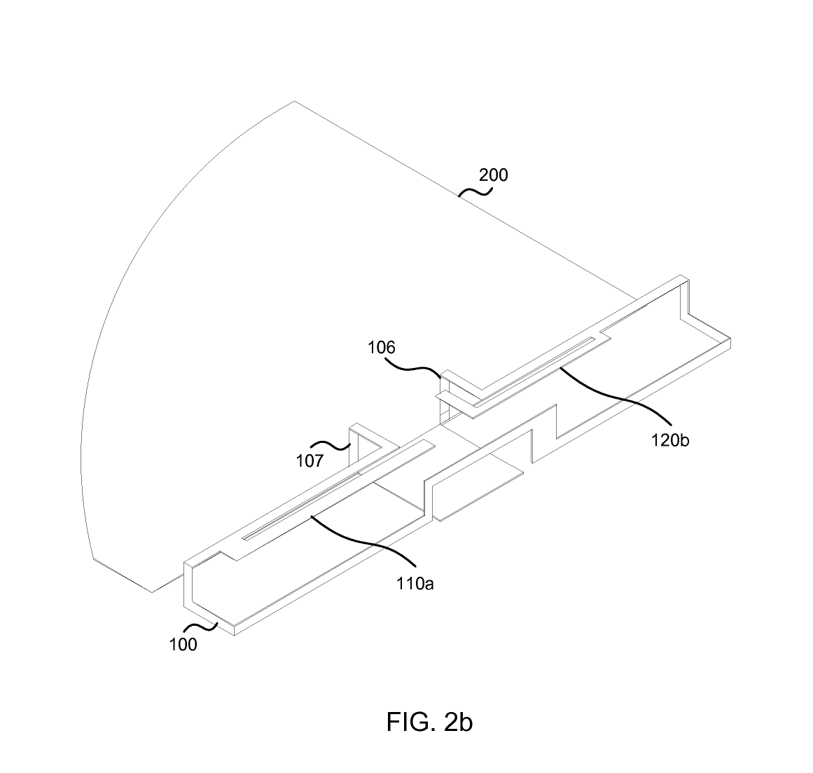

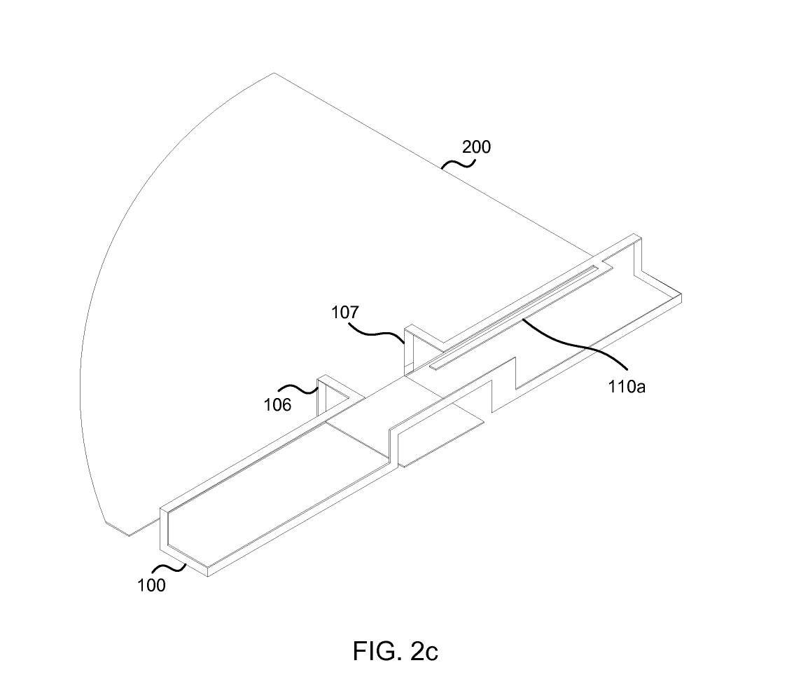

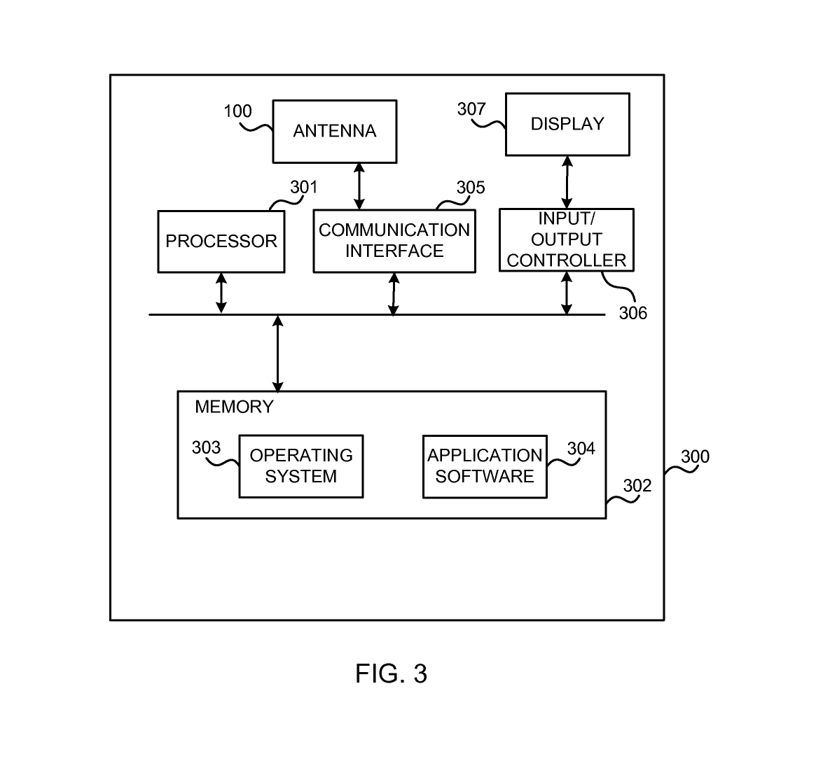

FIGS. 2a-2c are 3D views of various embodiments of the loop antenna 100. The loop antenna 100 is attached to an electrically conductive plate 200 acting as a ground plane. The plate 200 may be for example an inner back plate of a mobile apparatus, such as the mobile apparatus 300 of FIG. 3. The embodiment of FIG. 2a corresponds to that of FIG. 1e with like reference numerals used to designate like parts. FIG. 2b illustrates a close up of the embodiment of FIG. 2a. The embodiment of FIG. 2c corresponds to that of FIG. 1a with like reference numerals used to designate like parts.

The length of the first parasitic elements 110a, 110b and the length of the second parasitic elements 120, 120b may be substantially equal. Alternatively, the length of at least one of the first parasitic elements 110a, 110b and the second parasitic elements 120a, 120b may differ from the lengths of the other parasitic element(s).

The first parasitic elements 110a, 110b and the second parasitic elements 120, 120b may be symmetrically arranged within the loop element 101-107 with respect to each other. Alternatively, at least one of the first parasitic elements 110a, 110b and the second parasitic elements 120a, 120b may not symmetrically arranged within the loop element 101-107 with respect to the other parasitic element(s).

FIG. 3 illustrates various components of an exemplary mobile apparatus 300 which may be implemented as any form of a computing and/or electronic device.

The mobile apparatus 300 comprises one or more processors 301 which may be microprocessors, controllers or any other suitable type of processors for processing computer executable instructions to control the operation of the mobile apparatus 300. Platform software comprising an operating system 303 or any other suitable platform software may be provided at the mobile apparatus 300 to enable application software 304 to be executed on the device.

Computer executable instructions may be provided using any computer-readable media that is accessible by the mobile apparatus 300. Computer-readable media may include, for example, computer storage media such as memory 302 and communications media. Computer storage media, such as memory 302, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 302) is shown within the mobile apparatus 300 it will be appreciated that the storage may be distributed or located remotely and accessed via a network or other communication link (e.g. using communication interface 305).

The mobile apparatus 300 may comprise an input/output controller 306 arranged to output display information to a display device 307 which may be separate from or integral to the mobile apparatus 300. The input/output controller 306 may also be arranged to receive and process input from one or more devices, such as a user input device (e.g. a keyboard, camera, microphone or other sensor). In one example, the display device 307 may also act as the user input device if it is a touch sensitive display device. The input/output controller 306 may also output data to devices other than the display device, e.g. a locally connected printing device.

The input/output controller 306 may be in communication with one or more sensors such as one or more cameras, an inertial measurement unit and/or other sensors. This enables the mobile apparatus 300 to receive data observed by the sensors and to control the sensors.

The communication interface 305 may be used to receive a communication event via the antenna 100. The communication event may be, for example, an incoming call or an incoming message.

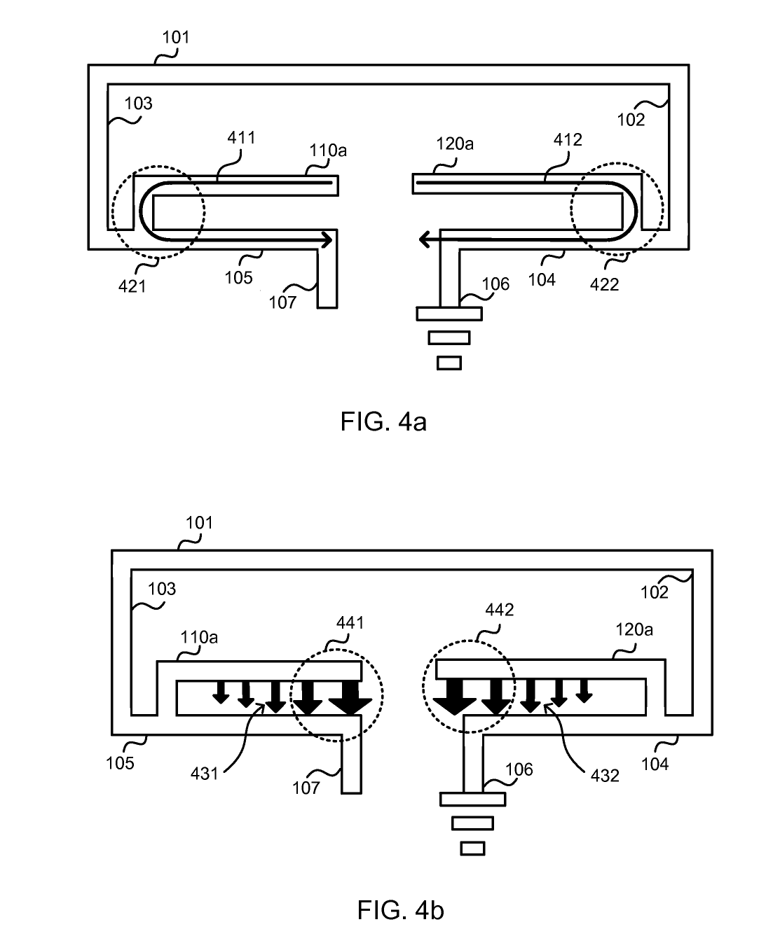

FIG. 4a illustrates currents associated with the third high band resonance 540 created with the loop antenna 100, and FIG. 4b illustrates electric fields associated with the third high band resonance 540 created with the loop antenna 100. In FIG. 4a, arrow 411 represents the current that is generated due to the first parasitic element 110a, and arrow 412 represents the current that is generated due to the second parasitic element 120a. Circles 421 and 422 represent the approximate areas in which the generated currents are at their maximum.

In FIG. 4b, arrows 431 represent the electric field vectors that are generated due to the first parasitic element 110a, and arrows 432 represent the electric field vectors that are generated due to the second parasitic element 120a. The size of the arrow visualizes the electric field strength. Accordingly, circles 441 and 442 represent the approximate areas in which the generated electric fields are at their maximum.

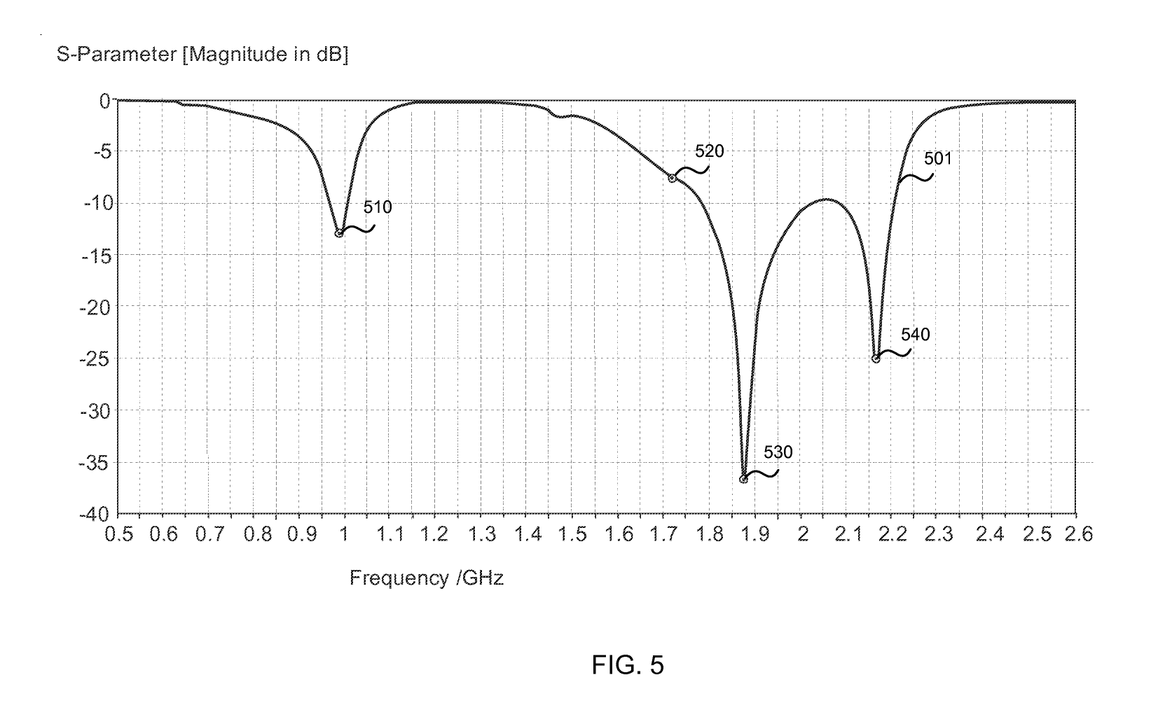

Accordingly, it can be seen from FIGS. 4a-4b that the slots formed between the parasitic elements 110a, 110b, 120a, 120b and the lower portions 104, 105 of the loop element act as a radiator(s) that create the third high band resonance 540 shown in FIG. 5.

FIG. 5 illustrates resonances created with the loop antenna 100. The horizontal axis represents frequency in gigahertz, and the vertical axis represents return loss (magnitude in decibels). Curve 501 represents return loss of the loop antenna 100. Point 510 represents a low band resonance which may be utilized e.g. to cover GSM (global system for mobile communications) 850/900 bands and/or WCDMA V and WCDMA VIII (wideband code division multiple access) bands. Points 520 and 530 represent first and second high band resonances which may be utilized e.g. to cover GSM 1800/1900 bands and/or WCDMA I and II bands. Point 540 represents a third high band resonance created with the slot radiators formed with the parasitic elements 110a, 110b, 120a, and/or 120b. The third high band resonance may be utilized e.g. to cover the downlink (RX) of the WCDMA I band.

At least some of the examples disclosed in FIGS. 1A-5 are able to provide band-enhancement for a loop antenna. When a parasitic element is added inside a loop antenna, the parasitic element acts as a slot radiator creating an additional third resonance, which can be used for example to cover WCDMA (wideband code division multiple access) I RX (receive) frequency band in mobile handsets. In other words, loop antenna bandwidth is extended. In addition, the enhanced bandwidth makes it possible to adjust high-band radiation properties by controlling resonance frequencies. This is due to the different radiation patterns of each resonance. This feature enables for example reducing body SAR (specific absorption rate) with antenna tuning. Furthermore, when a parasitic element is added inside a loop antenna, it makes it possible to adjust radiation pattern direction for example around GSM (Global System for Mobile Communications) 1800/1900 and WCDMA II bands. Furthermore, in embodiments using two parasitic elements of different lengths, an additional fourth resonance may be created.

An embodiment of a loop antenna comprises a loop element having a feed contact and a ground contact; and a first parasitic element arranged inside the loop element and acting as a first slot radiator, wherein a first end of the first parasitic element is physically connected to the loop element thereby forming a closed end of the first slot radiator, and wherein the first slot radiator further has an open end that is closer to the feed contact and the ground contact than its closed end.

In an embodiment, the loop element comprises a first lower portion and a second lower portion, an upper portion, a first side portion connecting the first lower portion and the upper portion, and a second side portion connecting the second lower portion and the upper portion, with the first lower portion connected to the ground contact and the second lower portion connected to the feed contact.

In an embodiment, the first end of the first parasitic element is physically connected to one of the first lower portion and the second lower portion of the loop element.

In an embodiment, the loop antenna further comprises a second parasitic element arranged inside the loop element and acting as a second slot radiator, wherein a first end of the second parasitic element is physically connected to the loop element thereby forming a closed end of the second slot radiator, and wherein the second slot radiator further has an open end that is closer to the feed contact and the ground contact than its closed end.

In an embodiment, the loop element comprises a first lower portion and a second lower portion, an upper portion, a first side portion connecting the first lower portion and the upper portion, and a second side portion connecting the second lower portion and the upper portion, with the first lower portion connected to the ground contact and the second lower portion connected to the feed contact.

In an embodiment, the first end of the first parasitic element is physically connected to one of the first lower portion and the second lower portion of the loop element, and the first end of the second parasitic element is physically connected to the other of the first lower portion and the second lower portion of the loop element than the first end of the first parasitic element.

In an embodiment, the length of the first parasitic element and the length of the second parasitic element are substantially equal.

In an embodiment, the length of the first parasitic element and the length of the second parasitic element differ from each other.

In an embodiment, the first parasitic element and the second parasitic element are symmetrically arranged.

In an embodiment, the first parasitic element and the second parasitic element are not symmetrically arranged.

In an embodiment, the first parasitic element extends substantially linearly from the closed end of the first slot radiator towards the open end of the first slot radiator.

In an embodiment, the second parasitic element extends substantially linearly from the closed end of the second slot radiator towards the open end of the second slot radiator.

In an embodiment, the loop element comprises a folded loop element.

In an embodiment, the first end of the first parasitic element is physically connected to the second lower portion of the loop element.

An embodiment of a loop antenna comprises a loop element having a feed contact and a ground contact; and a first parasitic element arranged inside the loop element and acting as a first slot radiator, wherein a first end of the first parasitic element is physically connected to the loop element thereby forming a closed end of the first slot radiator, and wherein the first slot radiator further has an open end that is closer to the feed contact and the ground contact than its closed end, wherein the first parasitic element first extends substantially linearly from the closed end of the first slot radiator towards the open end of the first slot radiator and then bends along one of the feed contact and the ground contact at the open end of the first slot radiator.

In an embodiment, the loop antenna further comprises a second parasitic element arranged inside the loop element and acting as a second slot radiator, wherein a first end of the second parasitic element is physically connected to the loop element thereby forming a closed end of the second slot radiator, and wherein the second slot radiator further has an open end that is closer to the feed contact and the ground contact than its closed end, wherein the second parasitic element first extends substantially linearly from the closed end of the second slot radiator towards the open end of the second slot radiator and then bends along the other of the feed contact and the ground contact than the first parasitic element at the open end of the second slot radiator.

In an embodiment, the loop element comprises a first lower portion and a second lower portion, an upper portion, a first side portion connecting the first lower portion and the upper portion, and a second side portion connecting the second lower portion and the upper portion, with the first lower portion connected to the ground contact and the second lower portion connected to the feed contact, wherein the first end of the first parasitic element is physically connected to one of the first lower portion and the second lower portion of the loop element.

An embodiment of a mobile apparatus comprises at least one processor; at least one memory storing program instructions; and a loop antenna comprising a loop element having a feed contact and a ground contact; and a first parasitic element arranged inside the loop element and acting as a first slot radiator, wherein a first end of the first parasitic element is physically connected to the loop element thereby forming a closed end of the first slot radiator, and wherein the first slot radiator further has an open end that is closer to the feed contact and the ground contact than its closed end.

In an embodiment, the loop element and the first parasitic element are formed as traces or printed conductive areas on a dielectric inner surface of the mobile apparatus.

In an embodiment, the dielectric inner surface is located in a lower portion of the mobile apparatus.

An embodiment of a mobile apparatus comprises at least one processor; at least one memory storing program instructions; and a loop antenna comprising a loop element having a feed contact and a ground contact; and a first parasitic element arranged inside the loop element and acting as a first slot radiator, wherein a first end of the first parasitic element is physically connected to the loop element thereby forming a closed end of the first slot radiator, and wherein the first slot radiator further has an open end that is closer to the feed contact and the ground contact than its closed end.

An embodiment of a loop antenna comprises a loop element having a feed contact and a ground contact; and a first parasitic element arranged inside the loop element and acting as a first slot radiator, wherein a first end of the first parasitic element is physically connected to the loop element thereby forming a closed end of the first slot radiator, and wherein the first slot radiator further has an open end that is closer to the feed contact and the ground contact than its closed end.

In an embodiment as any of those defined above, the loop element comprises a first lower portion and a second lower portion, an upper portion, a first side portion connecting the first lower portion and the upper portion, and a second side portion connecting the second lower portion and the upper portion, with the first lower portion connected to the ground contact and the second lower portion connected to the feed contact.

In an embodiment as any of those defined above, the first end of the first parasitic element is physically connected to one of the first lower portion and the second lower portion of the loop element.

In an embodiment as any of those defined above, the loop antenna further comprises a second parasitic element arranged inside the loop element and acting as a second slot radiator, wherein a first end of the second parasitic element is physically connected to the loop element thereby forming a closed end of the second slot radiator, and wherein the second slot radiator further has an open end that is closer to the feed contact and the ground contact than its closed end.

In an embodiment as any of those defined above, the loop element comprises a first lower portion and a second lower portion, an upper portion, a first side portion connecting the first lower portion and the upper portion, and a second side portion connecting the second lower portion and the upper portion, with the first lower portion connected to the ground contact and the second lower portion connected to the feed contact.

In an embodiment as any of those defined above, the first end of the first parasitic element is physically connected to one of the first lower portion and the second lower portion of the loop element, and the first end of the second parasitic element is physically connected to the other of the first lower portion and the second lower portion of the loop element than the first end of the first parasitic element.

In an embodiment as any of those defined above, the first parasitic element first extends substantially linearly from the closed end of the first slot radiator towards the open end of the first slot radiator and then bends along one of the feed contact and the ground contact at the open end of the first slot radiator.

In an embodiment as any of those defined above, the first parasitic element first extends substantially linearly from the closed end of the first slot radiator towards the open end of the first slot radiator and then bends along one of the feed contact and the ground contact at the open end of the first slot radiator, and the second parasitic element first extends substantially linearly from the closed end of the second slot radiator towards the open end of the second slot radiator and then bends along the other of the feed contact and the ground contact than the first parasitic element at the open end of the second slot radiator.

In an embodiment as any of those defined above, the length of the first parasitic element and the length of the second parasitic element are substantially equal.

In an embodiment as any of those defined above, the length of the first parasitic element and the length of the second parasitic element differ from each other.

In an embodiment as any of those defined above, the first parasitic element extends substantially linearly from the closed end of the first slot radiator towards the open end of the first slot radiator.

In an embodiment as any of those defined above, the second parasitic element extends substantially linearly from the closed end of the second slot radiator towards the open end of the second slot radiator.

In an embodiment as any of those defined above, the first parasitic element and the second parasitic element are one of symmetrically and asymmetrically arranged.

In an embodiment as any of those defined above, the loop element comprises a folded loop element.

The term ‘computer’, ‘computing-based device’, ‘apparatus’ or ‘mobile apparatus’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

Any range or device value given herein may be extended or altered without losing the effect sought.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

Aspects of any of the examples described above may be combined with aspects of any of the other examples described to form further examples without losing the effect sought.

The term ‘comprising’ is used herein to mean including the elements identified, but that such elements do not comprise an exclusive list and an antenna or apparatus may contain additional elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A loop antenna, comprising:
a loop element having a feed contact and a ground contact; and
a first parasitic element arranged inside the loop element and acting as a first slot radiator, wherein a first end of the first parasitic element is physically connected to the loop element thereby forming a closed end of the first slot radiator, and wherein the first slot radiator further has an open end that is closer to the feed contact and the ground contact than its closed end.

2. A loop antenna as claimed in claim 1, wherein the loop element comprises a first lower portion and a second lower portion, an upper portion, a first side portion connecting the first lower portion and the upper portion, and a second side portion connecting the second lower portion and the upper portion, with the first lower portion connected to the ground contact and the second lower portion connected to the feed contact.

3. A loop antenna as claimed in claim 2, wherein the first end of the first parasitic element is physically connected to one of the first lower portion and the second lower portion of the loop element.

4. A loop antenna as claimed in claim 1, further comprising a second parasitic element arranged inside the loop element and acting as a second slot radiator, wherein a first end of the second parasitic element is physically connected to the loop element thereby forming a closed end of the second slot radiator, and wherein the second slot radiator further has an open end that is closer to the feed contact and the ground contact than its closed end.

5. A loop antenna as claimed in claim 4, wherein the loop element comprises a first lower portion and a second lower portion, an upper portion, a first side portion connecting the first lower portion and the upper portion, and a second side portion connecting the second lower portion and the upper portion, with the first lower portion connected to the ground contact and the second lower portion connected to the feed contact.

6. A loop antenna as claimed in claim 5, wherein the first end of the first parasitic element is physically connected to one of the first lower portion and the second lower portion of the loop element, and the first end of the second parasitic element is physically connected to the other of the first lower portion and the second lower portion of the loop element than the first end of the first parasitic element.

7. A loop antenna as claimed in claim 4, wherein the length of the first parasitic element and the length of the second parasitic element are substantially equal.

8. A loop antenna as claimed in claim 4, wherein the length of the first parasitic element and the length of the second parasitic element differ from each other.

9. A loop antenna as claimed in claim 4, wherein the first parasitic element and the second parasitic element are symmetrically arranged.

10. A loop antenna as claimed in claim 4, wherein the first parasitic element and the second parasitic element are not symmetrically arranged.

11. A loop antenna as claimed in claim 1, wherein the first parasitic element extends substantially linearly from the closed end of the first slot radiator towards the open end of the first slot radiator.

12. A loop antenna as claimed in claim 4, wherein the second parasitic element extends substantially linearly from the closed end of the second slot radiator towards the open end of the second slot radiator.

13. A loop antenna as claimed in claim 1, wherein the loop element comprises a folded loop element.

14. A loop antenna as claimed in claim 3, wherein the first end of the first parasitic element is physically connected to the second lower portion of the loop element.

15. A loop antenna, comprising:
a loop element having a feed contact and a ground contact; and
a first parasitic element arranged inside the loop element and acting as a first slot radiator, wherein a first end of the first parasitic element is physically connected to the loop element thereby forming a closed end of the first slot radiator, and wherein the first slot radiator further has an open end that is closer to the feed contact and the ground contact than its closed end,
wherein the first parasitic element first extends substantially linearly from the closed end of the first slot radiator towards the open end of the first slot radiator and then bends along one of the feed contact and the ground contact at the open end of the first slot radiator.

16. A loop antenna as claimed in claim 15, further comprising a second parasitic element arranged inside the loop element and acting as a second slot radiator, wherein a first end of the second parasitic element is physically connected to the loop element thereby forming a closed end of the second slot radiator, and wherein the second slot radiator further has an open end that is closer to the feed contact and the ground contact than its closed end, and
wherein the second parasitic element first extends substantially linearly from the closed end of the second slot radiator towards the open end of the second slot radiator and then bends along the other of the feed contact and the ground contact than the first parasitic element at the open end of the second slot radiator.

17. A loop antenna as claimed in claim 15, wherein the loop element comprises a first lower portion and a second lower portion, an upper portion, a first side portion connecting the first lower portion and the upper portion, and a second side portion connecting the second lower portion and the upper portion, with the first lower portion connected to the ground contact and the second lower portion connected to the feed contact, and wherein the first end of the first parasitic element is physically connected to one of the first lower portion and the second lower portion of the loop element.

18. A mobile apparatus, comprising:
at least one processor;
at least one memory storing program instructions; and
a loop antenna comprising:
a loop element having a feed contact and a ground contact; and
a first parasitic element arranged inside the loop element and acting as a first slot radiator, wherein a first end of the first parasitic element is physically connected to the loop element thereby forming a closed end of the first slot radiator, and wherein the first slot radiator further has an open end that is closer to the feed contact and the ground contact than its closed end.

19. A mobile apparatus as claimed in claim 18, wherein the loop element and the first parasitic element are formed as traces or printed conductive areas on a dielectric inner surface of the mobile apparatus.

20. A mobile apparatus as claimed in claim 19, wherein the dielectric inner surface is located in a lower portion of the mobile apparatus.
